(19) United States
(12) Patent Application Publication
(10) Pub. No.: US 2007/0260549 A1
(43) Pub. Date: Nov. 8, 2007

(54) Intangible Property Transaction and Leaseback Business Method

(76) Inventor: P. Bradley Walker, Walker, WV (US)

Correspondence Address: P. Bradley Walker, Route 1, Box 88, Walker, WV, 26180, US

(21) Appl. No.: 11/381,682

(22) Filed: May 4, 2006

(51) Int. Cl. H04L 9/00

(52) U.S. Cl. 705/59

(57) ABSTRACT

A method and system for purchasing intangible property, such as intellectual property, from a seller allowing the seller to realize the true market value of the asset as opposed to its nominal book value. The method includes an agreement to license the rights of that property, whether exclusively or a limited basis, back to the seller in exchange for royalty payments. As such, the seller is allowed to realize the full capital appreciation of the asset while retaining the rights conferred by it for as long as the terms of the royalty agreement are maintained.

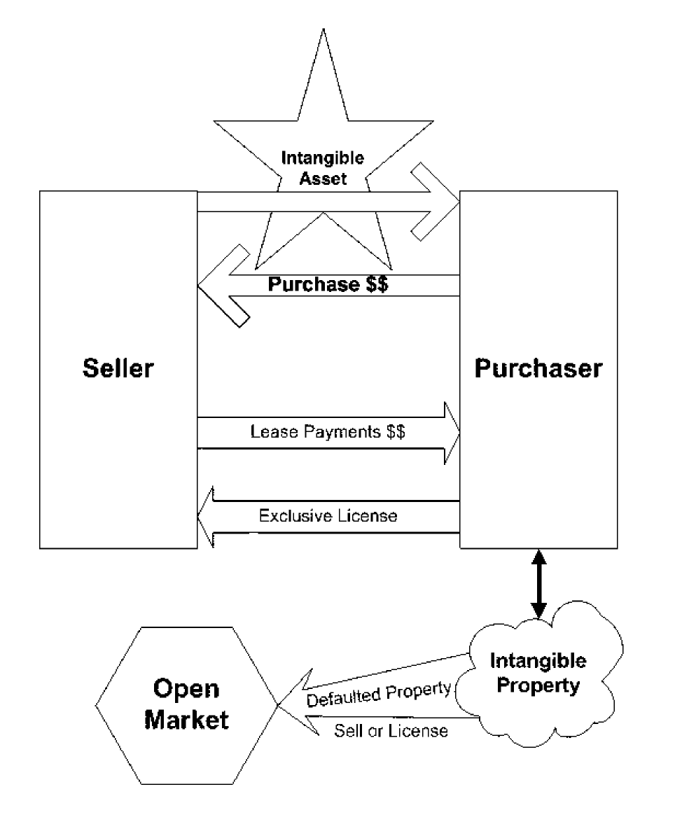

### BACKGROUND OF THE INVENTION

The invention is a business method that allows a corporation to realize a capital appreciation for any intangible property that it possesses. The mechanism described relates generally to a sales transaction from a seller to a purchaser with subsequent leaseback of certain rights relating to the intangible property. The transaction realizes a capital appreciation of the book value of the asset to a market value established via the transaction.

### DESCRIPTION OF THE RELATED ART

There is very little art relating to leasebacks for intangible property. Leaseback mechanisms for real property such as real estate or capital equipment have long been in existence, but these concepts have not migrated into intangible property, presumably due to the difficulty in establishing real market value for these types of assets. In order for the true market value for an intangible asset to be determined, like sales transactions must be known, but these are not readily verifiable in the case of intangible properties. Likewise, a sales transaction that realizes the true market value requires the asset to be surrendered.

The rational for a sale and leaseback mechanism is straightforward. The numbers of corporations increase daily that have developed patented technologies, yet lack the necessary capital to achieve significant commercial and industrial integration of those technologies. Accounting standards applicable to such corporations require that their patents be listed on the balance sheet (either personal or corporate) at the cost of development. However, given the potential for royalty income, pursuant to independent valuation, the patents will often appraise for ten, twenty, thirty or more times the cost of development.

The need for companies to realize this real value for these types of intangible properties in order to finance operations or increase the value of their net worth as reflected on their balance sheets is sufficient justification for the described business method. As mentioned above, intangible property appears on a company's balance sheet at the asset valuation determined by the actual investment incurred to secure the asset. This is typically quantified by the investment made in research and development funds to create the property, whether real or intangible. In many cases, the real value of the asset, in terms of market potential, is much higher than the listed book value. This book value, if used as collateral, may not be sufficient for the company to borrow the funds necessary to glean full market value from the asset. In some cases, the balance sheet of the company may carry significant debt, and is further hampered due to an undervaluing of its intangible assets. In these cases, the company's overall market value is grossly undervalued and its ability to raise capital is severely constrained. For these and other reasons, a mechanism is needed whereby a company can realize the true market value for these types of intangible assets without selling and surrendering them to a third party in open market transactions.

There are various patents describing mechanisms for valuing intangible property or insuring their value, but only a single application was found describing a sale and leaseback strategy that allows a company to maintain the benefits of the asset. Patent application 2005/0108118 describes the principle function of a patent pool entity consisting of a sale and leaseback, but involves only the transfer of non-exclusive rights (or something less than full rights) to the licensee by the licensor. The intent of application 2005/0108118 allows a patent investing company to generate revenue by licensing the patent to the seller as well as various other licensors (the primary objective of a patent pool) based on the residual rights that it retains. That method contrasts with the intent of this application granting all rights exclusively to the seller in exchange for payment. There is no intent or provision to generate additional income through re-licensing of the patent to third parties based on retained residual rights.

U.S. Pat. Nos. 6,018,714 and 6,959,280 describe mechanisms for insuring the value of a patent using an appraisal and third party to insure that value in the event that its appraised value drops at some point in the future. In neither of these patents is there a transaction or leaseback involved. U.S. Pat. No. 6,330,547 is a similar mechanism that involves a third party agreeing to insure a lender in the case of default by a borrower who used an intangible asset as collateral. The insured value is a computed liquidation value based on certain measurable parameters. This patent does not mention a transaction or leaseback arrangement. U.S. Pat. No. 6,556,992 describes a method for valuing an intangible asset for investment, licensing or litigation issues, but is a statistical model that does not include a transaction or leaseback. Patent application 2003/0009415 describes a model for trading futures based on an intangible assets future value, but this is simply a model for a trading exchange for potential investors.

### SUMMARY OF THE INVENTION

The business process described herein consists of the on-going purchase, management, sale, and re-sale, licensing and re-licensing of intangible properties with an eye toward increasing net asset value per share, earnings per share and dividends for the parties involved.

The intangible assets to be purchased and licensed consist of patents (pending or issued), trade secrets, trademarks, service marks or any intangible asset that has some form of goodwill inherent in its composition that would cause its market value to be higher than its book value.

The primary characteristics of the intangible property purchases involve sellers trading ownership of their property in exchange for exclusive license of the asset plus a combination of stock and/or cash that would have a worth closer to the appraised value than to the cost of development (the book value). The purchasing company, when it is an investment company registered under the Investment Company Act of 1940, as amended, would show a substantial unrealized capital gain on each transaction equal to the difference in each property's appraised value versus its cost of purchase. Generally Accepted Accounting Principles, as set forth by the Federal Accounting Standards Board, dictate this practice for such Investment Companies.

It is expected that the sellers of the intangible property will be sensible about the purchase price since they will agree to pay a set percentage of the purchase price as a royalty (at whatever terms are negotiated) in order to maintain exclusive license of the asset each year ad infinitum. For publicly held sellers such payment could consist of cash, stock, warrants or bonds. Default on seller's payment of the set royalty would trigger various re-licensing and/or re-sale alternatives to be set forth in the original purchase agreement.

The substantial increase to the selling corporation's net worth and liquidity resulting from such transactions would enable them to achieve significant commercial and industrial integration of the intangible assets otherwise unobtainable. At the very least, such transactions are designed to reduce or eliminate a seller's balance sheet debt. The selling entity could therefore become attractive to conventional capital sources. Thus, many sellers may be able to exercise their option to re-purchase their patents at a premium from the purchasing entity.

### BRIEF DESCRIPTION OF THE DRAWINGS

The included figure depicts the basic transaction relationship between the purchasing and selling entities. In the figure, the seller transfers ownership of an intangible asset to the purchaser in exchange for cash or other marketable securities. Seller then has the right to license any and all rights associated with the asset on an exclusive basis from seller for a predetermined royalty fee. In the event that seller defaults on the license fee, purchaser has the right to sell or license the intangible asset to anyone in the open market.

What is claimed is:

1. A business method for purchasing an intangible asset from seller with an agreement to license all rights of ownership to the asset back to the seller on an exclusive (or other agreed to) basis. The purchaser confers the agreed to rights regarding the asset to seller as long as seller maintains the terms of the license or lease agreement. In the event that seller defaults on the license/lease payments, purchaser may sell or license the asset to any third party.

2. The method of claim 1, where the intangible asset is a patent or patent application.

3. The method of claim 1, where the intangible asset is a trademark or service mark.

4. The method of claim 1, where the intangible asset is a trade secret.

5. The method of claim 1, where any intangible asset represents “good will” value above and beyond its stated book value.
